(19) United States
(12) Patent Application Publication
(10) Pub. No.: US 2025/0218187 A1
(43) Pub. Date: Jul. 3, 2025

(54) METHODS AND SYSTEMS FOR CLASSIFYING VEHICLES AS ELECTRIC OR NONELECTRIC BASED ON AUDIO

(71) Applicant: Robert Bosch GmbH, Stuttgart (DE)

(72) Inventors: Ibrahim Eshera, Clarksville, MD (US); Charles Shelton, Monroeville, PA (US); Samarjit Das, Wexford, PA (US)

(21) Appl. No.: 18/398,674

(22) Filed: Dec. 28, 2023

(51) Int. Cl. G06V 20/54; G06V 10/774; G06V 10/82; G06V 20/40; G08G 1/017; G08G 1/04

(52) U.S. Cl. CPC G06V 20/54; G06V 10/774; G06V 10/82; G06V 20/41; G06V 20/48; G08G 1/017; G08G 1/04; G06V 2201/08

(57) ABSTRACT

Methods and systems for training a neural network to identify an electric vehicle based on audio. Video data is generated from a camera with a field of view including a roadway. Audio data is generated from a microphone, the audio data associated with vehicles traveling across the roadway. The video data is segmented into segments, each having a start time and a finish time that corresponds to a respective vehicle traveling across the roadway in and out of the field of view. Each video segment is labeled with a label indicating the respective vehicle in that segment as either an electric vehicle or a non-electric vehicle. The audio data is segmented into segments, each having a start time and end time associated with a respective one of the video segments. A neural network is trained based on the audio segments and the labels of the associated video segments.

### TECHNICAL FIELD

The present disclosure relates to methods and systems for classifying vehicles as electric or non-electric based on audio.

### BACKGROUND

Internet of Things (IoT) systems based on machine and deep-learning algorithms are becoming pervasive in both industrial and consumer applications. The commercial success of such systems is strongly related to meeting expectations for accuracy, precision, recall, and coverage. The development of highly accurate deep-learning systems is directly influenced by the availability of a large and varied collection of training and evaluation data. A wide variety of evaluation data is necessary to assess the performance of a system before it is manufactured and deployed. A large amount of labeled data is key to training complex and large deep-learning models capable of meeting the desired levels of performance.

### SUMMARY

In embodiments, methods and systems for training a neural network to identify an electric vehicle based on audio are provided. Video data is generated from a camera with a field of view including a roadway. Audio data is generated from a microphone, the audio data associated with vehicles traveling across the roadway. The video data is segmented into segments, each having a start time and a finish time that corresponds to a respective vehicle traveling across the roadway in and out of the field of view. Each video segment is labeled with a label indicating the respective vehicle in that segment as either an electric vehicle or a non-electric vehicle. The audio data is segmented into segments, each having a start time and end time associated with a respective one of the video segments. A neural network is trained based on the audio segments and the labels of the associated video segments.

### BRIEF DESCRIPTION OF THE DRAWINGS

FIG. 1 generally illustrates a system for training a neural network according to an embodiment of the present disclosure.

FIG. 2 generally illustrates a computer-implemented method for training and utilizing a neural network according to an embodiment of the present disclosure.

FIG. 3A generally illustrates an audio/video data labeling system according to an embodiment of the present disclosure.

FIG. 3B generally illustrates a portion of a data capturing system according to the principles of the present disclosure.

FIG. 3C generally illustrates an alternative audio/video data labeling system, according to an embodiment of the present disclosure.

FIG. 4 generally illustrates a schematic of a system for training a neural network to identify an electric vehicle based on audio, according to an embodiment.

FIG. 5 generally illustrates a block diagram showing an overall schematic of a system for training a neural network to identify an electric vehicle based on audio, according to an embodiment.

FIG. 6 generally illustrates a flow chart of a method of training a neural network to identify an electric vehicle based on audio, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

IoT systems based on deep-learning algorithms are becoming pervasive in both industrial and consumer applications. The commercial success of such systems is strongly related to meeting customers' expectations in terms of accuracy, precision, recall, and coverage. The development of highly accurate deep-learning systems is directly influenced by the availability of a large and varied collection of training and evaluation data. A wide variety of evaluation data is necessary to assess the performance of a system before it is manufactured and deployed in the wild. A large amount of labeled data is key to training complex and large deep-learning models capable of meeting the desired levels of performance

The success of deep-learning solutions in real-world applications is highly related to the quality of data in performing the tasks they are designed for. When it comes to training and evaluating deep-learning systems, acquiring varied and large quantities of labeled data may be necessary to train the system effectively, and evaluate its performance under a variety of conditions.

At the same time, making sense of sounds is one of the growing topics in the Artificial Intelligence (AI) community. In several AI pipelines, specifically deep-learning-based ones, having access to large amount of labeled data is key to successfully tackling the task at hand. However, audio data collection and annotation are much more challenging compared to other domains such as vision, text etc.

Additionally, there are several reasons why it might be useful to identify whether vehicles (cars, trucks, SUVs, etc.) traveling on a particular road are electric vehcles (EVs) or non-electric vehicles (e.g., vehicles with internal combustion engines, ICEs). For example, understanding the proportion of electric vehicles versus non-electric vehicles can provide valuable data for assessing the environmental impact of transportation in that area. It allows for calculations regarding emissions reductions, carbon footprint, and overall pollution levels. Moreover, the identification of EVs versus non-EVs can help in planning and deploying the necessary infrastructure. For instance, if there's a high concentration of electric vehicles, there might be a need for more electric charging stations or different maintenance protocols for roads due to the differing weights and patterns of electric versus non-electric vehicles. Governments or local authorities may also use this information to shape policies, incentives, or regulations related to transportation. For instance, they might offer incentives for electric vehicle owners, such as parking discounts, toll exemptions, or other benefits to promote the adoption of cleaner transportation. Knowing the distribution of electric vehicles can also help in managing traffic flow. For instance, some areas might consider creating specific lanes or zones for electric vehicles, promoting smoother traffic patterns and reducing congestion.

This invention report discloses an audio-video data collection and labeling scheme to overcome some of these challenges. Also provided is a novel classification model to differentiate electric vehicles from non-electric vehicles that pass by or drive over a roadway. In embodiments, a tandem or synchronized camera and microphone array data collection setup is installed and configured to advance the vision domain to automatically label the vehicles appearing in the video. The proposed setup can be expanded to a combination of microphone array and other sensors that would provide automatic labeling for moving sound sources.

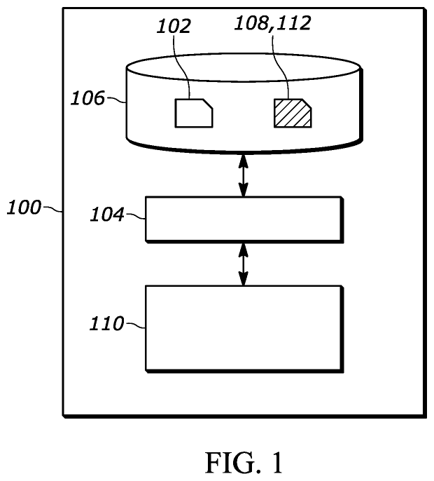

FIG. 1 shows a system 100 for training a neural network (e.g., of an ML model). The system 100 may be configured to (and/or include circuitry configured to) implement the systems and methods of the present disclosure described below in more detail. The system 100 may comprise an input interface for accessing training data 102 for the neural network. For example, as illustrated in FIG. 1, the input interface may be constituted by a data storage interface 104 which may access the training data 102 from data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also external data storage, e.g., network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

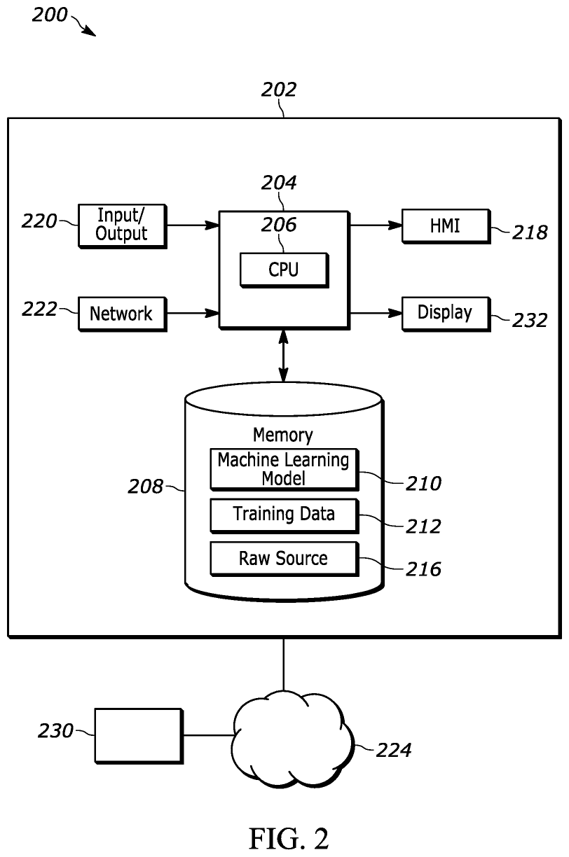

FIG. 2 depicts a data annotation/augmentation system 200 configured to (and/or including circuitry configured to) implement a system for annotating, labeling, and/or augmenting data. The data annotation system 200 may include at least one computing system 202 configured to implement all or portions of the systems and methods of the present disclosure explained below in more detail. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. Various components of the system 200 may be implemented with same or different circuitry.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 (e.g., represented in FIG. 2 as the ML Model 210) or algorithm, a training dataset 212 for the machine-learning model 210, raw source dataset 216, etc.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning model 210 that is configured to analyze the raw source dataset 216. For example, the CPU 206 and/or other circuitry may implement the machine-learning model 210. The raw source dataset 216 may include raw or unprocessed sensor data that may be representative of an input dataset for a machine-learning system. The raw source dataset 216 may include video, video segments, images, audio, text-based information, and raw or partially processed sensor data (e.g., radar map of objects). In some embodiments, the machine-learning model 210 may be a deep-learning or neural network algorithm that is designed to perform a predetermined function. For example, the neural network algorithm may be configured to identify events or objects in video segments based on audio data.

The computer system 200 may store the training dataset 212 for the machine-learning model 210. The training dataset 212 may represent a set of previously constructed data for training the machine-learning model 210. For example, the training dataset 212 according to the present disclosure may include multiple automatically-collected ground-truth measurements and associated data. The training dataset 212 may be used by the machine-learning model 210 to learn weighting factors associated with a neural network algorithm. The training dataset 212 may include a set of source data that has corresponding outcomes or results that the machine-learning model 210 tries to duplicate via the learning process.

The machine-learning model 210 may be operated in a learning mode using the training dataset 212 as input. The machine-learning model 210 may be executed over a number of iterations using the data from the training dataset 212. With each iteration, the machine-learning model 210 may update internal weighting factors based on the achieved results. For example, the machine-learning model 210 can compare output results (e.g., annotations) with those included in the training dataset 212. Since the training dataset 212 includes the expected results, the machine-learning model 210 can determine when performance is acceptable. After the machine-learning model 210 achieves a predetermined performance level (e.g., 100% agreement with the outcomes associated with the training dataset 212), the machine-learning model 210 may be executed using data that is not in the training dataset 212. The trained machine-learning model 210 may be applied to new datasets to generate annotated data.

The machine-learning model 210 may be configured to identify a particular feature in the raw source data 216. The raw source data 216 may include a plurality of instances or input dataset for which annotation results are desired (e.g., a video stream or segment including audio data). For example only, the machine-learning model 210 may be configured to identify objects or events in a video segment based on audio data and annotate the events. The machine-learning model 210 may be programmed to process the raw source data 216 to identify the presence of the particular features. The machine-learning model 210 may be configured to identify a feature in the raw source data 216 as a predetermined feature. The raw source data 216 may be derived from a variety of sources. For example, the raw source data 216 may be actual input data collected by a machine-learning system. The raw source data 216 may be machine generated for testing the system. As an example, the raw source data 216 may include raw video and/or audio data from a camera, audio data from a microphone, etc.

In an example, the machine-learning model 210 may process raw source data 216 and output video and/or audio data including one or more indications of an identified event. The machine-learning model 210 may generate a confidence level or factor for each output generated. For example, a confidence value that exceeds a predetermined high-confidence threshold may indicate that the machine-learning model 210 is confident that the identified event (or feature) corresponds to the particular event. A confidence value that is less than a low-confidence threshold may indicate that the machine-learning model 210 has some uncertainty that the particular feature is present.

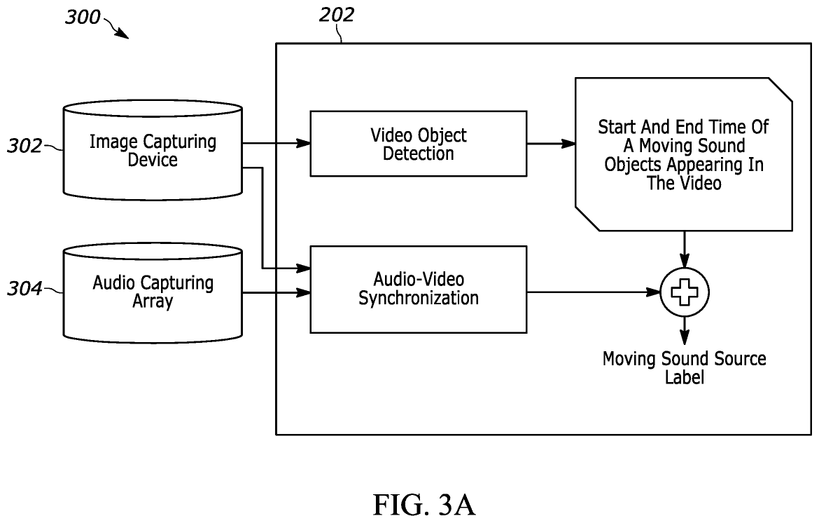

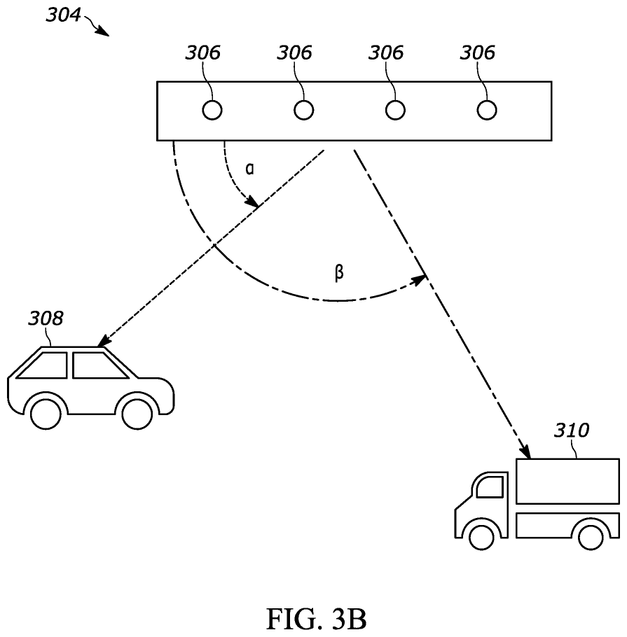

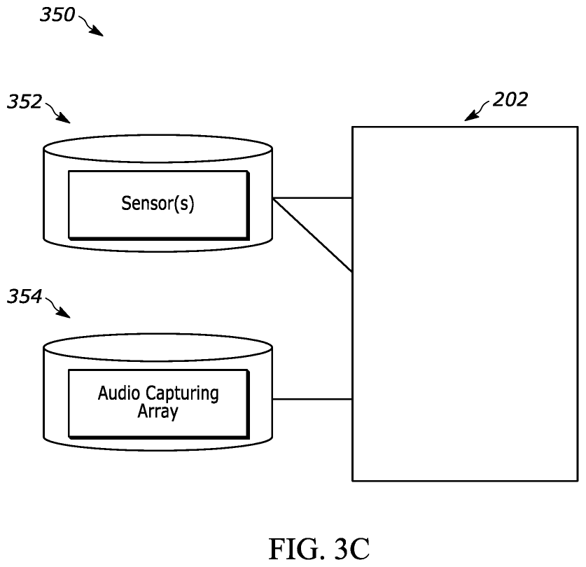

As is generally illustrated in FIGS. 3A and 3B, a system 300 may include an image (e.g., video) capturing device 302, an audio capturing array 304, and the computing system 202. The system may receive, from the image capturing device 302, video stream data associated with a data capture environment. The system 202 may be configured to perform video object detection to identify one or more objects (e.g., a vehicle) in corresponding images of the video stream data, and can optionally be equipped with a classification model or labeling model that can label the identified vehicle as either an EV or a non-EV based upon some given or learned database of images of EV and/or non-EV vehicles. The system 202 may receive, from the audio capturing array 304, audio stream data that corresponds to at least a portion of the video stream data. The audio capturing array 304 may include one or more microphones 306 or other suitable audio capturing devices. The systems and methods described herein may be configured to label, using output from at least a first machine-learning model (e.g., such as the machine-learning model 210 or other suitable machine-learning model configured to provide output including one or more object or event detection predictions), at least some objects of the video stream data and/or audio stream data.

The system 202 may calculate (e.g., using at least one probabilistic-based function or other suitable technique or function), based on at least one data capturing characteristic, at least one offset value for at least a portion of the audio stream data that corresponds to at least one labeled object of the video stream data. The system 202 may synchronize, using at least the at least one offset value, at least a portion of the video stream data with the portion of the audio stream data that corresponds to the at least one labeled object of the video stream data. The at least one data capturing characteristic may include one or more characteristics of the at least one image capturing device, one or more characteristics of the at least one audio capturing array, one or more characteristics corresponding to a location of the at least one image capturing device relative to the at least one audio capturing array, one or more characteristics corresponding to a movement of an object in the video stream data, one or more other suitable data capturing characteristics, or a combination thereof.

The system 202 may label, using one or more labels of the labeled objects of the video stream data and the at least one offset value, at least the portion of the audio stream data that corresponds to the at least one labeled object of the video stream data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model.

In some embodiments, as is generally illustrated in FIG. 3C, the computing system 202 may be configured to label audio data based on sensor data received from one or more sensors, such as those described herein or any other suitable sensor or combination of sensors. The system 202 may receive, from the audio capturing array 354 or any suitable audio capturing device, such as one or more of the microphones 306 or other suitable audio capturing device, audio stream data associated with a data capture environment. It should be understood that the audio capturing array 354 may include features similar to those of the audio capturing array 304 and may include any suitable number of audio capturing devices. The system 202 may receive, from at least one sensor (e.g., such as the sensor 352) that is asynchronous relative to the audio capturing array 354, sensor data associated with the data capture environment. The sensor 354 may include at least one of an induction coil, a radar sensor, a LiDAR sensor, a sonar sensor, an image capturing device, any other suitable sensor, or a combination thereof. The audio capturing array 354 may be remotely located from the sensor 354, proximately located to the sensor 354, or located in any suitable relationship to the sensor 354.

The system 202 may identify, using output from at least a first machine learning model, such as the machine learning model 210 or other suitable machine learning model, at least some events in the sensor data. The machine learning model 210 may be configured to provide output including one or more event detection predictions based on the sensor data. The system 202 may synchronize at least a portion of the sensor data associated with the portion of the audio stream data that corresponds to the at least one event of the sensor data. The system 202 may label, using one or more labels extracted for respective events of the sensor data value, at least the portion of the audio stream data that corresponds to the at least one event of the sensor data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model. The second machine-learning model may include any suitable machine-learning model and may be configured to perform any suitable function.

Any of the systems described above and/or below in more detail may be configured to implement automated collection of ground-truth data using multiple different sensors to train a machine or deep learning model according to the present disclosure. In one example, a microphone array is installed at or near a roadway on which vehicles (e.g., both EVs and non-EVs) travel. The roadway may be a highway, urban road, intersection, parking lot, or any other suitable roadway in which both EVs and non-EVs alike travel. An image-based model is trained to identify and label a passing vehicle as either an EV or non-EV. An audio-based model is trained to understand detected sounds that correspond to the vehicle passing by in the synchronized video data.

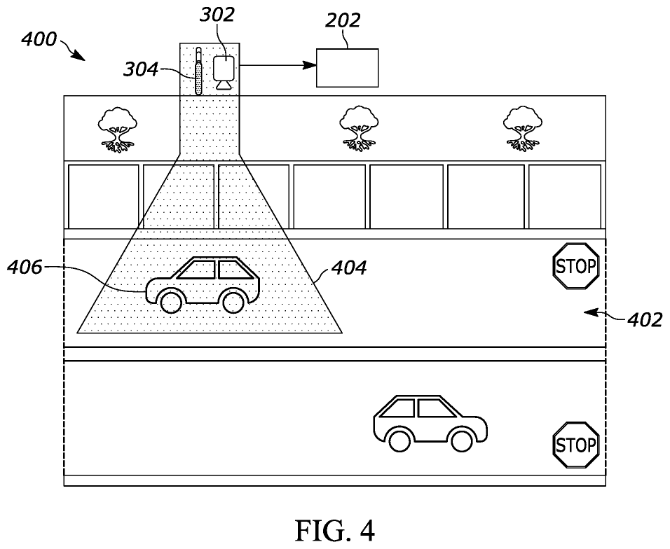

FIG. 4 illustrates a schematic view of a system 400 for training a neural network to identify an electric vehicle based on audio, according to an embodiment. The system 400 includes an image sensor (e.g., camera 302) and an audio sensor (e.g., microphone array 304, or one or more microphones). The data generated by the camera 302 and microphone(s) 304 is sent to computing system 202 for processing as described herein. The camera 302 is positioned and installed at or near a roadway 402 so as to have a field of view (FoV) 404 that includes a portion of the roadway. The camera 302 can therefore generates images, video, and associated data of vehicles 406 that pass by the camera 302 on the roadway 402 within the FoV 404.

As vehicles 406 pass by, the camera 302 captures video of the vehicles entering and exiting the FoV 404. This data can be processed by the computing system 202 to determine whether the vehicle in the image/video is an EV or non-EV. For example, a classification model or other object recognition model 210 may be utilized to compare the images of the vehicle to stored images of other vehicles that are known to be EVs or non-EVs. The classification model can be a neural network such as a convolutional neural network (CNN), Residual Neural Network (ResNet), a pre-trained model with large datasets like ImageNet, or the like. This model may be a pretrained object recognition model configured to automatically track and label the objects in the video stream as either an EV or non-EV vehicle. Based on the comparison of the image of the vehicle 406 to the database of images, the classification model can then determine whether the vehicle 406 in the FoV 404 is an EV or a non-EV.

Meanwhile, the audio sensor (e.g., microphone array 304, microphone 306) can be installed nearby to generate audio data relating to the vehicles passing by on the roadway 402. The audio sensor can be synchronized with the camera 302 so that the moments that the vehicle 406 enters and exits the FoV 404 can be logged and corresponded with the associated sound data of that moment. This allows a segment of audio data to be developed, with its segment corresponding to the segment of video data in which the vehicle 406 is in the FoV 404.

This data can be processed by the computing system 202 to train a machine learning model to understand and recognize sounds of an EV. In particular, the system 202 understands based on object recognition that a particular vehicle passing by is an EV. Since the sound data is synchronized with the video data, the system can segment or isolate the audio data that corresponds to when the EV is in the FoV. This data can be used as training data to train an audio-based neural network to learn sounds that correspond to EVs. For example, feature generation can be implemented in which relevant information or characteristics (features) from the audio data are extracted and used as input for the machine learning algorithms.

Rejection of non-related auditory cues can be critical for the task of isolating the sound of the passing-by vehicle for labeling that particular noise as being associated with an EV or non-EV. For example, noise from other vehicles, horns, traffic, and the like, if not handled, has the potential to reduce the accuracy of the model. With a multi-array microphone system, beam forming techniques can be used to narrow the received reflection within an acceptable range. With a single array system, other noise isolation techniques can be used to reject the non-related noise events other than the vehicles that pass by.

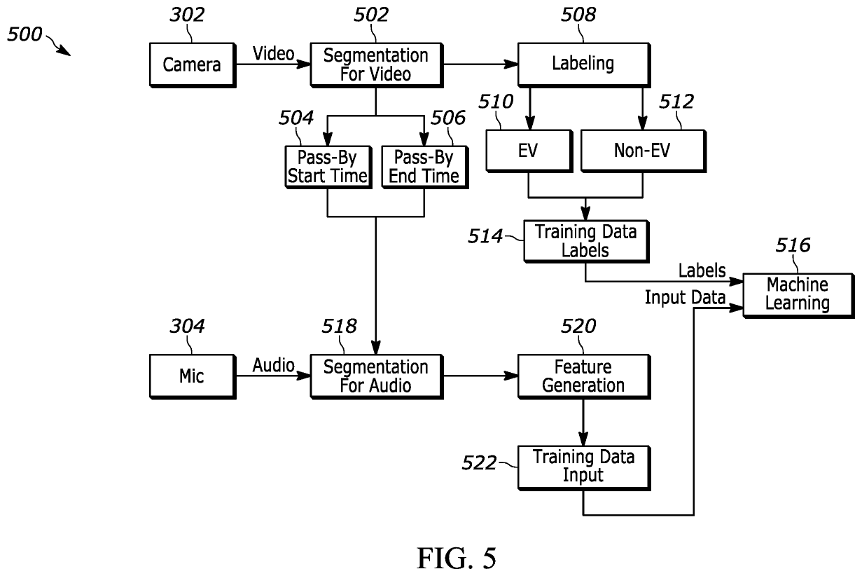

FIG. 5 illustrates a block diagram showing an overall schematic of a system 500 for training a neural network to identify an electric vehicle based on audio, according to an embodiment. The system 500 may be implemented or executed by one or more components of the computer systems disclosed herein. A camera, such as camera 302, is configured to generate video and associated data (generally referred to as image data) associated with a FoV in which vehicles drive through. Meanwhile, a microphone or microphone array (generally referred to as one or more microphones) 304 is configured to generate audio or audio data associated with the vehicles driving by.

The video or image data is sent to a neural network or machine learning model for segmentation, generally shown at 502. The model can be one of the models or neural networks described herein, such as, for example, a pretrained object recognition model configured to automatically track and label the objects in the video stream as either an EV or non-EV vehicle. The model can generate metadata associated with the objects detected in the video stream, including a time when the vehicle enters the scene or field of view of the camera (shown at 504) and a time when the vehicle exits the scene or field of view of the camera (shown at 506). The portion of the video between the start time 504 and the end time 506 can be isolated, segmented, clipped, and labeled accordingly so that it can be referred to and recalled later.

For identification and labeling of the vehicles in the video (e.g., as EV or non-EV), the neural network or machine learning model can rely on one or more computer vision models configured to identify and categorize objects within the images or video generated by the image sensor. The model can rely on and implement neural networks and deep learning techniques, such as convolutional neural networks (CNNs) for example.

In one embodiment, the machine learning model includes an object detection and classification model such as MobileNet, e.g., MobileNetV1, MobileNetV2, MobileNetV3, etc. MobileNet is configured for mobile and embedded vision applications and employs depthwise separable convolutions to reduce computation while preserving accuracy. With depthwise separable convolutions, MobileNet separates standard convolutions into two layers—depthwise convolutions and pointwise convolutions—to reduce the number of parameters and computational complexity. With depthwise convolution, it applies a single filter to each input channel separately. With pointwise convolution, it performs a 1×1 convolution to combine the outputs of depthwise convolutions across channels. As the image passes through the network, each layer extracts and transforms the input into higher-level representations. These representations gradually encode more complex and abstract features of the image. MobileNet can also utilize Rectified Linear Unit (ReLU) activation functions after most layers of the neural network, which, combined with batch normalization, aids in the training process and network performance. The final layers (or layers after the convolutional layers) of the neural network can include a global average pooling layer and a fully connected layer to perform classification. This averages the feature maps spatially, reducing the spatial dimensions and aggregating the important features. Finally, the processed features from the convolutional layers are fed into fully connected layers, followed by a softmax activation function. The softmax function outputs a probability distribution over the predefined classes/categories.

During training, MobileNet is trained on a dataset with labeled images using techniques like backpropagation and gradient descent. It learns to adjust its parameters (weights and biases) to minimize the difference between predicted and actual labels.

During inference (e.g., when the model is deployed to classify new, unseen images such as images of the surveillance scene), the trained MobileNet takes an image as input and performs forward propagation through its layers to generate predictions. The output includes of class probabilities, indicating the likelihood of the input image belonging to different predefined classes.

In another embodiment, the machine learning model includes an object detection and classification model such as You Only Look Once (YOLO), such as YOLOv1, YOLOv2, YOLOv3, etc. YOLO is an object detection and classification model that not only localizes object within an image but also classifies them. YOLO divides the input image into a grid of cells. Each cell in the grid is responsible for predicting bounding boxes and class probabilities. Unlike some other object detection methods, YOLO performs predictions directly on this grid in one pass through the network. Anchor boxes (e.g., predetermined bounding box shapes and sizes) can be relied upon to assist in predicting accurate bounding box coordinates for objects of various shapes and sizes within each grid cell. Rather than using multiple stages or region proposals, YOLO makes predictions for bounding boxes and class probabilities directly from the grid cells in a single pass through the network. Each grid cell predicts multiple bounding boxes along with class probabilities for those boxes. The architecture uses a backbone network (e.g., Darknet-53 in YOLOv3) to extract features from the input image. These features are passed through convolutional layers to capture both low-level and high-level features. Convolutional layers within the network learn to predict bounding box coordinates (e.g., x, y, width, height) relative to the grid cells. YOLO predicts bounding boxes with respect to each grid cell, combining predictions across the entire image. In addition to bounding box predictions, YOLO assigns class probabilities to each bounding box. It predicts the probability of each predefined class for each bounding box, indicating the likelihood that the detected object belongs to a specific class.

During training, YOLO optimizes its parameters by minimizing a combined loss function, which includes components for localization error (bounding box coordinates) and classification error (class probabilities). Techniques like backpropagation and gradient descent are used to update the neural network's weights.

During inference, YOLO takes an input image, passes it through the trained network, and generates bounding boxes along with class probabilities for objects detected within the image.

Pretrained classes can be relied upon by the machine learning model, and can include, for example, identification of an object as a vehicle, and identification of that vehicle as either an electric vehicle or a non-electric vehicle based upon a stored database of both types of vehicles.

Using such machine learning models described herein, the system 500 labels the video segment at 508. In particular, the metadata generated by the model associated with the video segment can include a label on the detected and identified vehicle. Such label can include an identification that the vehicle is an EV at 510, or an identification that the vehicle is a non-EV at 512. Each identification can come with a confidence or probably score as determined by the machine learning model.

The labeled image or video data can then yield training data labels at 514. In other words, the video segments and/or associated images within the video, along with the labeled data indicating the identified vehicle is an EV or non-EV, can provide training data for the machine learning model 516.

Additionally, the video segment between the start time 504 and the end time 506 in which the vehicle is in the field of view is segmented and isolated at 518 for audio analysis. In particular, a machine learning model can process the audio data generated by the microphone 304 during the time between the start time 504 and the end time 506. In particular, feature generation at 520 can be implemented, according to the teachings provided elsewhere herein. In embodiments, the feature generation 520 can refer to the process of extracting relevant information or characteristics (features) from the audio data that can be used as input for the machine learning algorithms. These extracted features are used for training the models to perform various tasks such as classification, segmentation, sound event detection, or other audio-related tasks described herein. Feature generation can involve converting the raw or preprocessed audio signals into a set of numeric features that capture different aspects of the audio content. The techniques used for feature generation can include spectrogram generation, which involves transforming the audio signal into a spectrogram which represents the frequency content of the signal over time. This can involve performing a Short-Time Fourier Transform (STFT) or other time-frequency analysis to create a 2D matrix of intensity values corresponding to different frequencies at each time frame. The feature generation can also include Mel-Frequency Cepstral Coefficients (MFCCs) (e.g., FIG. 5B) which involves taking the log of the power spectrum of the audio signal at specific Mel-spaced frequency bands. In either embodiment, once these features are extracted, they can form a numerical representation of the audio signal, enabling machine learning algorithms to learn patterns and relationships within the data for specific tasks. The result of the feature generation is training data input 522, which can be used to train the machine learning model at 516 to perform the segmentation, labeling, feature generation, and the like.

The training of the machine learning model at 516 can be based on the training data labels 514 from the video data, and the training data input 522 from the audio data. In embodiments, video segments themselves are not utilized in training the machine learning model 516. Rather, the audio data used for training the model is associated with a label (e.g., EV or non-EV) which is generated using computer vision techniques described herein. Therefore, once the machine learning model is trained with the audio data and the associated labels, it can determine whether a passing-by vehicle is an electric vehicle or a non-electric vehicle based on audio alone (i.e., without the need for video processing).

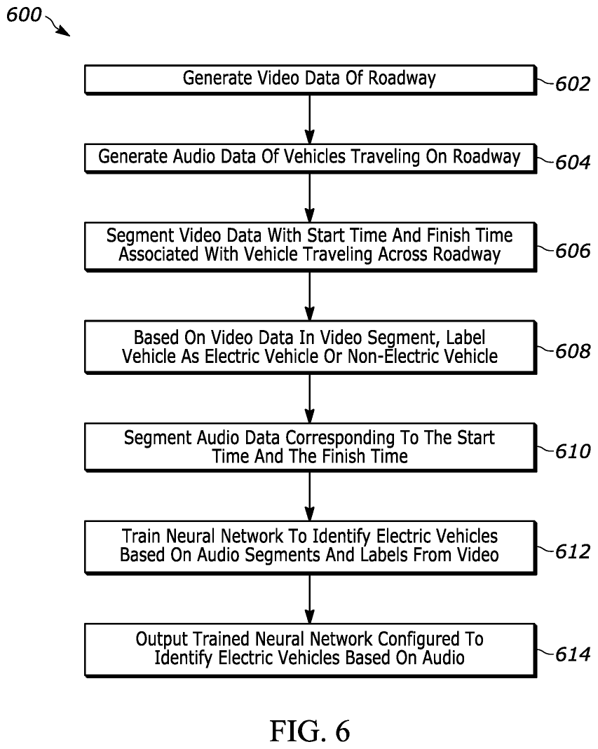

FIG. 6 illustrates a method 600 for training a neural network to identify an electric vehicle based on audio, according to an embodiment. The method 600 can be performed by any of the systems described herein, such as computing system 202, and can be on or with one or more of the machine learning models described herein.

At 602, video data or image data is generated. In an embodiment, a camera or other image sensor is placed at or near a roadway, and has a field of view that includes at least part of the roadway. The video data includes vehicles traveling across the roadway, into and out of the field of view.

At 604, audio data is generated, for example by one or more microphone or microphone array as described herein. The microphone(s) can be positioned at or near a roadway so as to capture sounds emitted by vehicle that drive across the roadway near the microphone(s). This audio data can be raw audio data, or preprocessed (e.g., denoise or the like). The microphone can be positioned near or adjacent the image sensor.

At 606, the generated video data or video is segmented into a plurality of segments. Each segment includes a start time and a finish time that correspond to a respective vehicle traveling across the roadway within the field of view. One or more object recognition models or computer vision techniques described herein can be utilized to detect the presence and location of a vehicle in the field of view. The metadata associated with that detected vehicle can include a time stamp of when the vehicle appears in the field of view and when the vehicle leaves the field of view.

At 608, each video segment is labeled indicating the vehicle in that video segment as either an electric vehicle or a non-electric vehicle. Various labeling schemes or techniques can be utilized, such as those described herein. For example, the neural network or machine learning model can compare the detected vehicle to a database of vehicles with labels, and match the detected vehicle to the class of vehicles in the database. Each vehicle or audio segment is provided with a label, such as EV or non-EV, depending on the identified vehicle.

At 610, the audio data is segmented into a plurality of segments. The audio data is associated with the video data such that each segment can correspond to a respective one of the video data segments. As such, each audio data segment can have a start time and an end time that correspond to the start time and the finish time of the respective video segment. The start time and the end time of the audio segment may not necessarily be identical to the corresponding start time and the end time of the video segment, but in embodiments they are identical. Thus, each audio segment corresponds to the noise detected by a vehicle as the vehicle enters and exits the field of view of the image sensor.

At 612, a machine learning model or neural network is trained to identify electric vehicles based on the audio segments and the labels of the respective video segments. In other words, the audio data of a particular audio segment, as well as the label of the video segment that is associated with that particular audio segment, is fed into the machine learning model. The model therefore associates the sound emitted by the vehicle with a label of associated video (and therefore representative of what that vehicle sounds like, with a label associated with whether that vehicle is an EV or a non-EV).

At 614, the training results in a trained neural network configured to identify electric vehicles based on audio, i.e., the sounds emitted by that vehicle. The neural network may be fully trained once convergence of the training data is met. Once trained, the model does not need to rely on video data, as the video was used to create labels associated with the audio that was used to train the model.

Teachings provided herein result an advancement in the field due to the increased popularity of EVs in recent years skyrocketing, putting millions of relatively silent vehicles on the road. The systems disclosed herein rely solely on passive acoustics which is resilient to future changes in the vehicle industry as EVs are likely to consistently sound the same or similar over the next generations of vehicles. As more and more EV's are quickly entering the market, a camera-based system would need to be continuously updated, trained, and redeployed in order to maintain a high level of accuracy. In addition, the trained model can be implemented in a variety of settings. For example, if deployed at an intersection or roadway in which pedestrians frequent, an alarm can be deployed warning pedestrians of the upcoming presence of an EV traveling down the roadway when the pedestrian may not be able to hear it. A speaker or other type of alarm may be commanded to alert pedestrians of the upcoming EV as detected by the machine learning model executing on audio data.

Rejection of non-related auditory cues may be critical for the disclosed system and further work can be done in this domain to advance this technology from the noise rejection and engine isolation perspective. With a multi-array microphone system, beam forming techniques can be used to narrow the received reflection within acceptable range. With a single array system, other noise isolation techniques can be used to reject all other noise events other than the engine passing by.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for training a neural network to identify an electric vehicle based on audio, the method comprising:
generating video data from a camera, wherein the camera has a field of view of a roadway;
generating audio data from a microphone, wherein the audio data is associated with vehicles traveling across the roadway;
segmenting the video data into a plurality of video segments, wherein each video segment has a start time and a finish time that corresponds to a respective vehicle traveling across the roadway within the field of view;
based on the respective vehicle in each video segment, labeling each video segment with label indicating the respective vehicle as either an electric vehicle or a non-electric vehicle;
segmenting the audio data into a plurality of audio segments, wherein each audio segment has a start time and a finish time associated with that of a respective one of the video segments;
training a neural network to identify electric vehicles based on the audio segments and the labels of the respective video segments; and
based on the training, outputting a trained neural network configured to identify electric vehicles based on audio.

2. The method of claim 1, further comprising:
associating each audio segments with a respective one of the labels;
wherein the training includes training the neural network based on each audio segment and its respective label.

3. The method of claim 1, wherein the trained neural network is configured to identify electric vehicles based on audio and not video.

4. The method of claim 1, wherein the start time and the finish time of each audio segment is identical to the start time and finish time of the video segment.

5. The method of claim 1, wherein the microphone is installed adjacent to the camera.

6. The method of claim 1, further comprising:
executing an object detection and classification machine learning model to identify and classify the vehicles;
wherein the start time and the finish time associated with each video segment is associated with the respective vehicle entering the field of view and exiting the field of view, respectively.

7. The method of claim 6, wherein the object detection and classification machine learning model generates the labels of each video segment based upon the classification of the vehicles.

8. A system for training a neural network to identify an electric vehicle based on audio, the system comprising:
an image sensor having a field of view of a roadway and configured to generate video data;
an audio sensor configured to generate audio data associated with vehicles traveling across the roadway; and
a processor in communication with the image sensor and the audio sensor, the processor programmed to:
segment the video data into a plurality of video segments, wherein each video segment has a start time and a finish time that corresponds to a respective vehicle traveling across the roadway within the field of view;
based on the respective vehicle in each video segment, label each video segment with label indicating the respective vehicle as either an electric vehicle or a non-electric vehicle;
segment the audio data into a plurality of audio segments, wherein each audio segment has a start time and a finish time associated with that of a respective one of the video segments;
train a neural network to identify electric vehicles based on the audio segments and the labels of the respective video segments; and
based on the training, output a trained neural network configured to identify electric vehicles based on audio.

9. The system of claim 8, wherein the processor is further programmed to associate each audio segment with a respective one of the labels;
wherein the training of the neural network includes training the neural network based on each audio segment and its respective label.

10. The system of claim 8, wherein the trained neural network is configured to identify electric vehicles based on audio and not video.

11. The system of claim 8, wherein the start time and the finish time of each audio segment is identical to the start time and finish time of the video segment.

12. The system of claim 8, wherein the audio sensor is installed adjacent the image sensor.

13. The system of claim 8, wherein the processor is further programmed to:
execute an object detection and classification machine learning model to identify and classify the vehicles;
wherein the start time and the finish time associated with each video segment is associated with the respective vehicle entering the field of view and exiting the field of view, respectively.

14. The system of claim 13, wherein the object detection and classification machine learning model generates the labels of each video segment based upon the classification of the vehicles.

15. A non-transitory computer-readable storage medium storing executable instructions that, when executed by one or more processors, cause the processor to:
generate video data from a camera, wherein the camera has a field of view of a roadway;
generate audio data from a microphone, wherein the audio data is associated with vehicles traveling across the roadway;
segment the video data into a plurality of video segments, wherein each video segment has a start time and a finish time that corresponds to a respective vehicle traveling across the roadway within the field of view;
based on the respective vehicle in each video segment, label each video segment with label indicating the respective vehicle as either an electric vehicle or a non-electric vehicle;
segment the audio data into a plurality of audio segments, wherein each audio segment has a start time and a finish time associated with that of a respective one of the video segments;
train a neural network to identify electric vehicles based on the audio segments and the labels of the respective video segments; and
based on the training, output a trained neural network configured to identify electric vehicles based on audio.

16. The non-transitory computer-readable storage medium of claim 15, wherein the executable instructions, when executed by the one or more processors, cause the one or more processors to:
associate each audio segments with a respective one of the labels;
wherein the training includes training the neural network based on each audio segment and its respective label.

17. The non-transitory computer-readable storage medium of claim 15, wherein the trained neural network is configured to identify electric vehicles based on audio and not video.

18. The non-transitory computer-readable storage medium of claim 15, wherein the start time and the finish time of each audio segment is identical to the start time and finish time of the video segment.

19. The non-transitory computer-readable storage medium of claim 15, wherein the executable instructions, when executed by the one or more processors, cause the one or more processors to:
execute an object detection and classification machine learning model to identify and classify the vehicles;
wherein the start time and the finish time associated with each video segment is associated with the respective vehicle entering the field of view and exiting the field of view, respectively.

20. The non-transitory computer-readable storage medium of claim 19, wherein the object detection and classification machine learning model generates the labels of each video segment based upon the classification of the vehicles.
